(19) United States
(12) Patent Application Publication
(10) Pub. No.: US 2006/0089099 A1
(43) Pub. Date: Apr. 27, 2006

(54) Method and apparatus for allowing communication units to utilize non-licensed spectrum

(76) Inventors: Gregory J. Buchwald, Crystal Lake, IL (US); Lawrence M. Ecklund, Wheaton, IL (US); Steven F. Gillig, Roselle, IL (US); Stephen L. Kuffner, Algonquin, IL (US); S. David Silk, Barrington, IL (US)

Correspondence Address: MOTOROLA, INC., 1303 EAST ALGONQUIN ROAD, IL01/3RD, SCHAUMBURG, IL, 60196, US

(21) Appl. No.: 10/973,529

(22) Filed: Oct. 26, 2004

(51) Int. Cl. H04B 7/00

(52) U.S. Cl. 455/41.2; 455/73

(57) ABSTRACT

A method and apparatus for allowing communication units to utilize non-licensed spectrum is provided herein. In particular, when a radio determines a need to transmit within non-licensed spectrum, the radio searches for a beacon being transmitted. The beacon identifies a priority of the current user of the non-licensed spectrum. If the radio's priority is higher than the current user of the non-licensed spectrum, or if no beacon is heard, the radio may begin transmitting within the non-licensed spectrum. As part of the radio's transmission, a beacon will be broadcast by the radio identifying the radio's priority.

### FIELD OF THE INVENTION

The present invention relates generally to wireless communications, and in particular, to a method and apparatus for allowing communication units to utilize non-licensed spectrum.

### BACKGROUND OF THE INVENTION

Current methods for government allocation of frequency spectrum oftentimes results in inefficient use of the frequency spectrum. For example, government agencies typically license spectrum for police, fire, taxi, cellular, and other users of wireless communication systems. Communication for individual units may only take place utilizing the spectrum allocated (licensed) for communication, even if no communication is taking place in the non-licensed spectrum. Thus, it is oftentimes the case where users licensed for using a particular frequency will be prevented from communicating over the frequency because of high demand for the frequency, even though non-licensed spectrum (i.e., spectrum licensed to a different user) is available for utilization. Therefore, a need exists for a method and apparatus for allowing communication units to utilize non-licensed spectrum when their licensed spectrum is unavailable.

### BRIEF DESCRIPTION OF THE DRAWINGS

FIG. 1 is a block diagram of a radio communication unit.

FIG. 2 illustrates a beacon format.

FIG. 3 is a flow chart showing operation of the radio communication unit of FIG. 1 in accordance with a first embodiment of the present invention.

FIG. 4 is a flow chart showing operation of the radio communication unit of FIG. 1 in accordance with a second embodiment of the present invention.

### DETAILED DESCRIPTION OF THE DRAWINGS

To address the above-mentioned need a method and apparatus for allowing communication units to utilize non-licensed spectrum is provided herein. In particular, when a radio determines a need to transmit within non-licensed spectrum, the radio searches for a beacon being transmitted. The beacon identifies a priority of the current user of the non-licensed spectrum. If the radio's priority is higher than the current user of the non-licensed spectrum, or if no beacon is heard, the radio may begin transmitting within the non-licensed spectrum. As part of the radio's transmission, a beacon will be broadcast by the radio identifying the radio's priority.

By utilizing a beacon to prioritize transmissions, additional non-licensed spectrum may be utilized in a coordinated fashion when needed. This provides an otherwise free, open method for users to transmit within spectrum that they are not licensed to use, while providing an absolute guarantee of non-interference with the licensee.

The present invention encompasses a method for allowing a radio to transmit within a non-licensed frequency band. The method comprises the steps of determining a need for the radio to transmit within the frequency band, determining if a beacon is heard, and analyzing the beacon to determine a priority of the beacon transmitter. Transmission within the frequency band takes place when no beacon is heard or when the radio has a higher priority than the priority of the beacon transmitter.

The present invention additionally encompasses a radio comprising a receiver for receiving a beacon, logic circuitry for analyzing the beacon to determine a priority of the beacon transmitter, and a transmitter for transmitting within the frequency band when no beacon is heard or when the radio has a higher priority than the priority of the beacon transmitter.

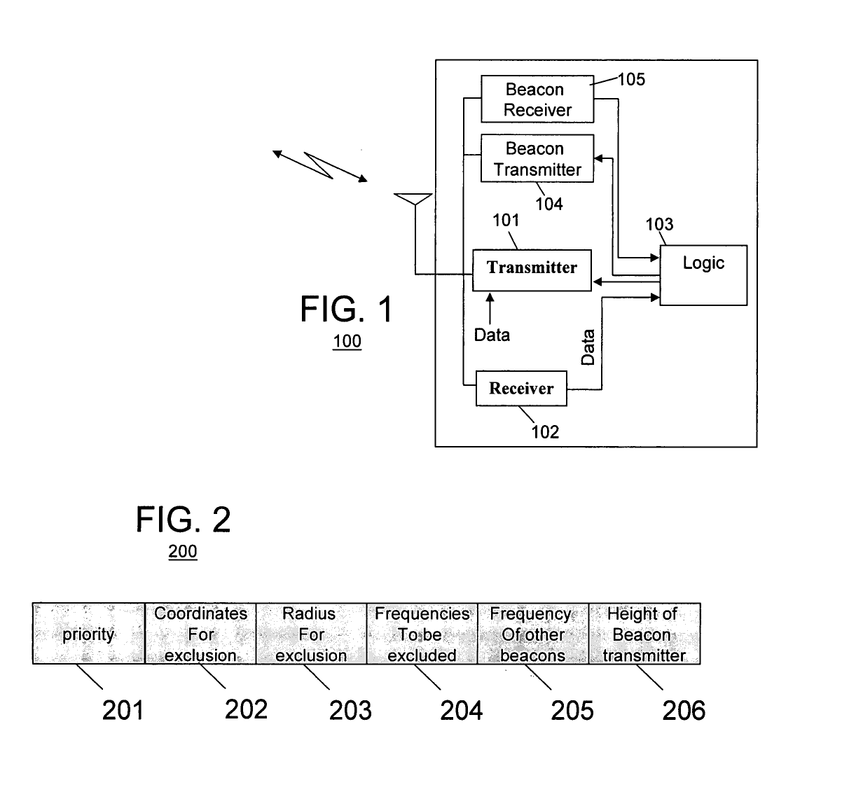

Turning now to the drawings, wherein like numerals designate like components, FIG. 1 is a block diagram of communication unit 100. In the preferred embodiment of the present invention radio 100 is a modified 2-way radio, such as a modified GM1225, an IEEE Adaptive Communication Device, or Spectra Radio available from Motorola Inc., however in alternate embodiments of the present invention radio 100 may comprise any stationary or portable radio. Such radios include, but are not limited to a cellular telephone, radios participating within wireless area networks such as wireless computers utilizing one of the IEEE 802 family of system protocols, medical telemetry equipment, wireless microphones, security systems, . . . , etc.

Radio 100 comprises transmitter 101, receiver 102, logic unit 103, beacon transmitter 104, and beacon receiver 105. Logic unit 103 preferably comprises a microprocessor controller, such as, but not limited to a Motorola PowerPC microprocessor. In the preferred embodiment of the present invention logic unit 103 serves as means for controlling radio 100, and as means for analyzing beacon contents to determine an ability to utilize non-licensed spectrum. Receive and transmit circuitry 101 and 102 are common circuitry known in the art for communication utilizing a well known communication system protocols, and serve as means for transmitting and receiving information/data. In the one embodiment of the present invention transmitter 101 and receiver 102 utilize an Association of Public Safety Communication Officials Project 25 (APCO-25) system protocol; however, in alternate embodiments of the present invention other system protocols may be utilized. Such system protocols include, but are not limited to the integrated dispatch enhanced network (iDEN) protocol, the terrestrial trunked radio (TETRA) protocol, the global system for mobile communication (GSM) protocol, the Enhanced Data Rate for Global Evolution (EDGE) protocol, the Bluetooth protocol, the IEEE 802.11 protocol, and the HyperLAN system protocol. In addition, new standards such as IEEE 802.16 or other high speed internet access/data conveyance links, such as those which may be utilized by a Wireless Regional Area Network/Wireless Internet Service Provider (WRAN/WISP), may also be used.

Beacon transmitter 104 and receiver 105 serves as means for transmitting and receiving a beacon. It should be noted that although FIG. 1 shows beacon transmitter 104 and beacon receiver 105 existing within radio 100 as a separate entity, one of ordinary skill in the art will recognize that beacon transmitter 104 and beacon receiver 105 may be integrated with transmitter 101, receiver 102, or both. Additionally, beacon transmitter 104 and beacon receiver 105 may exist external to radio 100, with several radios sharing a single beacon transmitter and receiver.

FIG. 2 illustrates beacon 200 for allowing communication units to utilize non-licensed spectrum. Non-licensed spectrum includes any spectrum in which a user is not licensed to utilize. Beacon 200 is preferably broadcast on a frequency within the non-licensed frequency band and comprises low-speed data easily decoded by all secondary users. Beacon 200 at least comprises a priority level 201 of radio 100, and preferably comprises data identifying coordinates for exclusion 202, a radius for exclusion 203, the frequencies to be excluded 204 from use by others, frequencies 205 of additional beacon channels to be monitored, and a height of the beacon transmitter 206. The height of the beacon transmitter may be utilized by individual radios 100 to further determine geographic coverage restrictions.

As discussed above, when transmitting in non-licensed spectrum, a radio will broadcast a beacon comprising priority level 201. Other users may transmit within the non-licensed spectrum only if their priority level 201 is higher than the current user of the non-licensed spectrum. It should be noted though, that in some instances a user of non-licensed spectrum will only need to transmit within a small geographic area. Because of this, beacon 200 preferably comprises additional data such as the geographic location 202 (e.g., latitude/longitude) for restricted transmissions (geographic area of restricted transmission), along with a radius 203 for which restriction is required. Thus, a user of non-licensed spectrum will be able to reserve the spectrum in certain geographic areas, allowing others to transmit within the spectrum outside the geographic area. In a similar manner, a user of non-licensed spectrum may wish to only reserve a portion of the spectrum for use. Because of this, the frequencies to be excluded 204 from use by others are provided within beacon 200.

By utilizing beacon 200 to prioritize transmissions, additional non-licensed spectrum may be utilized in a coordinated fashion at large-scale emergency incidents. This provides an otherwise free, open method for other users of this spectrum to coexist, while providing an absolute guarantee of quality of service for primary underlay users when situations warrant. For example, in an emergency situation, the police/fire may overwhelm their licensed spectrum. When this happens, they will be able to utilize non-licensed spectrum from other users, provided the spectrum is not being utilized by radios having a higher priority. To do this, all radios will firstly listen for a beacon of higher priority being transmitted. If none is heard, the radios will begin broadcasting their own beacon reserving, for example, unused television spectrum (i.e., a particular channel, or a particular frequency). Broadcasting beacon 200 will prevent other radios of lower priority from transmitting/receiving within the reserved spectrum.

As discussed above, any user of the non-licensed spectrum may wish to reserve the spectrum within a specified geographic area. Therefore, radios transmitting within the unused television spectrum may reserve the spectrum, for example, for two miles around a particular geographic location (i.e., building, city block, latitude/longitude, . . . , etc.).

The above method and apparatus for allowing communication units to utilize non-licensed spectrum allows for prioritized use of non-licensed spectrum, where users are restricted from transmitting within the non-licensed spectrum (i.e., spectrum not licensed to them) unless they have a higher priority than a current user of the spectrum. It is envisioned that multiple priorities may exist. For example, for utilization of non-licensed television spectrum it is envisioned that:
a) Licensed television broadcasting would receive the highest priority level of protection.
b) A second priority level of primary protection would be granted to legacy health/life-sustaining functions such as medical telemetry equipment. While the license to operate this equipment is implied in the type acceptance of this equipment, it must, nonetheless, be granted a high priority.
c) A third primary priority level would be used for television production /wireless microphones and/or other high priority users to be determined through legislation at a later date. Essentially, this priority level will be held in reserve for future prioritization action by the FCC, industry committees such as IEEE, or other sanctioned bodies. Furthermore, the existing license held by the community, governmental agency, or other concerned party to operate primary channel on an itinerate basis, may also imply a license to operate at high priority in underutilized television spectrum.
d) The fourth priority level of users will have several sub-levels. These users may include non-emergency and convenience users such as last mile, WAN, and LAN wireless operators.
e) The final priority level, essentially a sub-level of the fourth priority level, would include non-Part 74 wireless microphones, portable-to-portable computer data and/or voiced communications, and self-installed home network systems.

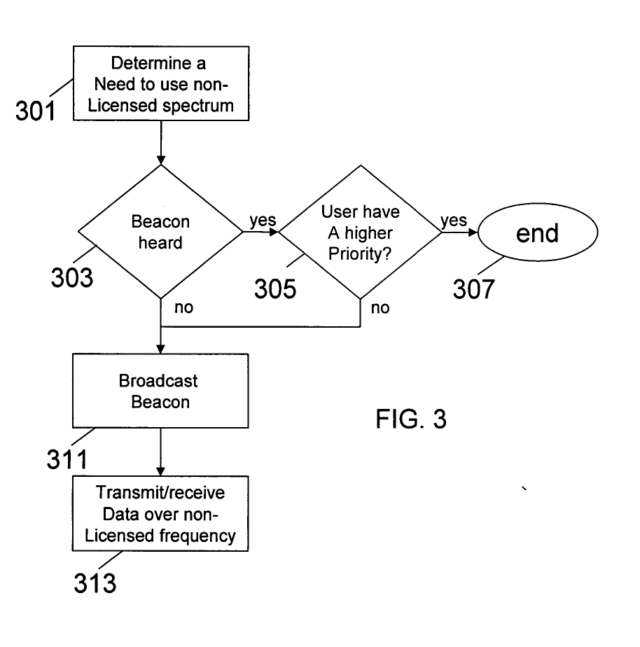

FIG. 3 is a flow chart showing operation of radio communication unit 100 of FIG. 1. The logic flow begins at step 301 where logic unit 103 determines a need to use non-licensed spectrum. As discussed, the use of non-licensed spectrum may be because of a high demand for licensed spectrum (i.e. spectrum that unit 100 is licensed to use), preventing unit 100 from using the licensed spectrum. At step 303 logic unit 103 accesses beacon receiver 105 to determine if a beacon is heard. If a beacon is heard at step 303, the logic flow continues to step 305, otherwise the logic flow continues to step 311.

At step 305 logic unit 103 analyzes the beacon to determine the priority of the beacon transmitter and determines the beacon transmitter has a higher priority by analyzing priority field 201. If it is determined at step 305 that the beacon heard has a higher priority than unit 100 the logic flow ends at step 307, otherwise the logic flow continues to step 311.

At step 311, logic unit instructs beacon transmitter to broadcast an appropriate beacon. The beacon will be constructed by logic unit 103 and will comprise at least priority field 201. At step 313 data transmission and reception takes place over the non-licensed frequency band via transmitter 101 and receiver 102. As discussed, the step of transmitting may include utilizing a protocol taken from the group consisting of a Association of Public Safety Communication Officials Project 25 (APCO-25) system protocol, an integrated dispatch enhanced network (iDEN) protocol, a terrestrial trunked radio (TETRA) protocol, a global system for mobile communication (GSM) protocol, an Enhanced Data Rate for Global Evolution (EDGE) protocol, a Bluetooth protocol, an IEEE 802.11 protocol, a HyperLAN system protocol, and an IEEE802.16 protocol.

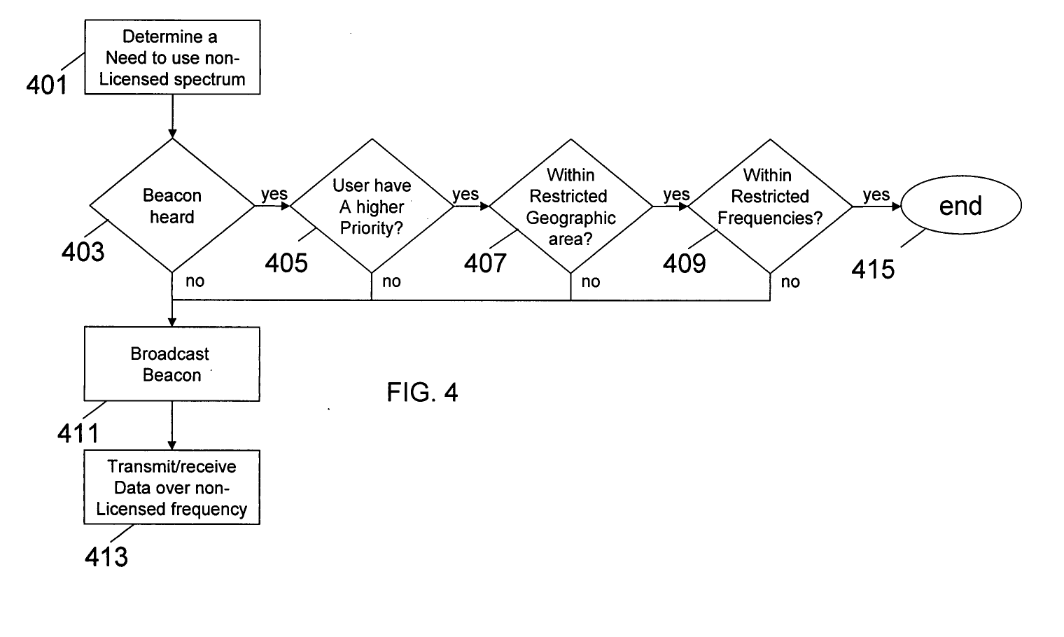

FIG. 4 is a flow chart showing operation of radio communication unit 100 of FIG. 1 in accordance with a second embodiment. In the second embodiment the ability for unit 100 to broadcast over non-licenses spectrum is additionally based on a restricted area of transmission and a restricted frequency, both of which are contained within the beacon. The logic flow begins at step 401 where logic unit 103 determines a need to use non-licensed spectrum. As discussed, the use of non-licensed spectrum may be because of a high demand for licensed spectrum (i.e. spectrum that unit 100 is licensed to use), preventing unit 100 from using the licensed spectrum. At step 403 logic unit 103 accesses beacon receiver 105 to determine if a beacon is heard. If a beacon is heard at step 403, the logic flow continues to step 405, otherwise the logic flow continues to step 411.

At step 405 logic unit 103 analyzes the beacon to determine the priority of the beacon transmitter and if determines the beacon transmitter has a higher priority by analyzing priority field 201. If it is determined at step 405 that the beacon heard has a higher priority than unit 100 the logic flow continues to step 407, otherwise the logic flow continues to step 411. In the first embodiment, simply hearing a beacon with a higher priority will preclude transmission within the non-licensed frequency band; however in the second embodiment this may not preclude transmission within the non-licensed frequency band if the current user only restricts transmissions within a geographic area. Therefore, at step 407 logic unit analyzes fields 202 and 203 to determine an area of restricted transmission and if radio 100 is within the restricted geographic area. If so, the logic flow continues to step 409, otherwise the logic flow continues to step 411.

At step 409, logic unit 103 analyzes field 204 to determine restricted frequencies. As discussed, in the first embodiment, simply hearing a beacon with a higher priority will preclude transmission within the non-licensed frequency band, however in the second embodiment transmission within the non-licensed frequency band may be precluded on certain frequencies only, therefore, at step 409 logic unit 103 analyzes the beacon to determine restricted frequencies and determines if the restricted frequency in field 204 matches the frequency of desired transmission. If so the logic flow ends at step 415, otherwise the logic flow continues to step 411.

At step 411, logic unit instructs beacon transmitter to broadcast an appropriate beacon (second beacon). The beacon will be constructed by logic unit 103 and will comprise appropriate fields 201-206 for priority, coordinates for exclusion, frequencies for exclusion, frequencies of other beacons, and height of beacon transmitter. At step 413 data transmission and reception takes place over the non-licensed frequency band via transmitter 101 and receiver 102.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for allowing a radio to transmit within a non-licensed frequency band, the method comprising the steps of:
determining a need for the radio to transmit within the frequency band;
determining if a beacon is heard;
analyzing the beacon to determine a priority of the beacon transmitter; and
transmitting within the frequency band when no beacon is heard or when the radio has a higher priority than the priority of the beacon transmitter.

2. The method of claim 1 wherein the step of determining the need for the radio to transmit within the frequency band comprises the step of determining that a high demand exists for spectrum the radio is licensed to use.

3. The method of claim 1 further comprises the steps of:
analyzing the beacon to determine a geographic area of restricted transmission; and
transmitting within the frequency band when a higher-priority beacon is heard and the geographic area of transmission is not restricted.

4. The method of claim 1 further comprises the steps of:
analyzing the beacon to determine restricted frequencies; and
transmitting within an unrestricted frequency band when a higher-priority beacon is heard.

5. The method of claim 1 further comprises the steps of:
analyzing the beacon to determine an area of restricted transmission;
analyzing the beacon to determine restricted frequencies; and
transmitting within an unrestricted frequency band when a higher-priority beacon is heard or transmitting within the frequency band when a higher-priority beacon is heard and the area of transmission is not restricted.

6. The method of claim 1 wherein the step of transmitting comprises the step of transmitting utilizing a protocol taken from the group consisting of an Association of Public Safety Communication Officials Project 25 (APCO-25) system protocol, an integrated dispatch enhanced network (iDEN) protocol, a terrestrial trunked radio (TETRA) protocol, a global system for mobile communication (GSM) protocol, an Enhanced Data Rate for Global Evolution (EDGE) protocol, a Bluetooth protocol, an IEEE 802.11 protocol, a HyperLAN system protocol, and of the IEEE 802 family of system protocols.

7. The method of claim 1 further comprising the step of:
transmitting a second beacon.

8. The method of claim 7 wherein the step of transmitting the second beacon comprises the step of transmitting a second beacon comprising a priority of the radio.

9. The method of claim 7 wherein the step of transmitting the second beacon comprises the step of transmitting a second beacon comprising a priority of the radio, and an area of restricted transmission.

10. The method of claim 7 wherein the step of transmitting the second beacon comprises the step of transmitting a second beacon comprising a priority of the radio, and a restricted frequency.

11. The method of claim 7 wherein the step of transmitting the second beacon comprises the step of transmitting a second beacon comprising a priority of the radio, a restricted frequency, and an area of restricted transmission.

12. The method of claim 7 wherein the step of transmitting the second beacon comprises the step of transmitting a second beacon comprising a height of a beacon transmitter.

13. A radio comprising:
a receiver for receiving a beacon;
logic circuitry for analyzing the beacon to determine a priority of the beacon transmitter; and
a transmitter for transmitting within the frequency band when no beacon is heard or when the radio has a higher priority than the priority of the beacon transmitter.

14. The radio of claim 13 wherein the logic circuitry additionally analyzes the beacon to determine an area of restricted transmission.

15. The radio of claim 13 wherein the logic circuitry additionally analyzes the beacon to determine restricted frequencies.

16. The radio of claim 13 wherein the transmitter utilizes a protocol taken from the group consisting of a Association of Public Safety Communication Officials Project 25 (APCO-25) system protocol, an integrated dispatch enhanced network (iDEN) protocol, a terrestrial trunked radio (TETRA) protocol, a global system for mobile communication (GSM) protocol, an Enhanced Data Rate for Global Evolution (EDGE) protocol, a Bluetooth protocol, and one of the IEEE 802 family of system protocols.

17. The radio of claim 13 wherein the transmitter transmits a second beacon.

18. The radio of claim 17 wherein the second beacon comprises a priority of the radio.

19. The radio of claim 17 wherein the second beacon comprises a priority of the radio, and an area of restricted transmission.

20. The radio of claim 17 wherein the second beacon comprises a priority of the radio, and a restricted frequency.

21. The radio of claim 17 wherein the second beacon comprises a priority of the radio, a restricted frequency, and an area of restricted transmission.
